(19) United States
(12) Patent Application Publication
(10) Pub. No.: US 2025/0126445 A1
(43) Pub. Date: Apr. 17, 2025

(54) Wide Spectrum Safety Sensor and Vehicle Alarm System

(71) Applicant: Diana Cosey, Granville, NY (US)

(72) Inventor: Diana Cosey, Granville, NY (US)

(21) Appl. No.: 18/588,290

(22) Filed: Feb. 27, 2024

Related U.S. Application Data
(60) Provisional application No. 63/589,335, filed on Oct. 11, 2023.

(51) Int. Cl. H04W 4/38; G08B 21/14; H04W 4/40; H04W 64/00

(52) U.S. Cl. CPC H04W 4/38; G08B 21/14; H04W 4/40; H04W 64/00

(57) ABSTRACT

A safety and alarm system for vehicles which is designed to enhance safety by preventing risks associated with leaving vulnerable individuals or pets in locked vehicles is disclosed. The system comprises a durable, weatherproof housing attachable to the ceiling of the vehicle including one or more of a 360-degree infra-red camera, a motion sensor in the vehicle seats, CO2, CO, and temperature sensors. Each sensor is associated with a predetermined threshold. The system includes a processor and a wireless chip, and communicates with a handheld electronic device, enabling real-time alerts and remote monitoring. The smartphone application associated with the system enables for customization of alerts, holographic display controls on the windows, viewing of vehicle interior and communication with vehicle occupants via camera, and system activation/deactivation. Additionally, the system includes GPS functionality for emergency location tracking, enhancing the safety and response measures in critical situations.

### CROSS-REFERENCE TO RELATED APPLICATION

The present application claims priority to, and the benefit of, U.S. Provisional Application No. 63/589,335, which was filed on Oct. 11, 2023, and is incorporated herein by reference in its entirety.

### FIELD OF THE INVENTION

The present invention generally relates to the field of vehicle alarm systems. More specifically, the present invention relates to a novel wide spectrum safety sensor system designed to be installed inside a vehicle. The system includes different sensors including a motion sensor, a carbon dioxide sensor, a carbon monoxide sensor, an infrared camera, and temperature sensors that work together to identify a child or pet in a vehicle. The system features a smartphone application that can receive an alert from the sensor system when the system is activated and detects a hazardous situation. The system also displays holographic images on the windows and windshield of the vehicle. The system also triggers the vehicle's onboard alarm system to attract the attention of passersby if there is no response within a safe response period and sends a notification to 911 along with GPS coordinates. Accordingly, the present disclosure makes specific reference thereto. Nonetheless, it is to be appreciated that aspects of the present invention are also equally applicable to other like applications, devices, and methods of manufacture.

### BACKGROUND

By way of background, in the current fast-paced world, it is not uncommon for individuals, especially parents and pet owners, to be preoccupied with their daily routines and responsibilities and this can lead to situations where they forget a child or pet in the back seat of their vehicle. Different reasons such as phone calls or an unusual disruption in their daily routine contribute to such oversights. Leaving a child or pet in a vehicle can be dangerous and even fatal for the child or pet.

Vehicles can quickly become extremely hot or cold, depending on the external weather conditions. In hot weather, for example, the temperature inside a parked car can soar to dangerous levels in just a few minutes. This can lead to heatstroke, particularly in children and pets who are less able to regulate their body temperature and are more susceptible to its effects. When a car is turned off in an enclosed space, such as a garage, there is a risk of carbon monoxide (CO) buildup if the engine is accidentally left running or restarted.

Traditional vehicle systems are not equipped to recognize and respond to the presence of unattended children or pets. The systems do not provide alerts to the driver or nearby individuals about the life form present in a locked vehicle after the driver has left, potentially leading to dangerous situations. Conventional systems also lack the capability to alert emergency services automatically in situations where a child or pet is in danger. Another limitation of current systems is the absence of a mechanism to alert passersby or nearby individuals. In many emergency situations, the immediate response of nearby individuals can be lifesaving, especially if they are made aware of a critical situation within a parked vehicle.

Therefore, there exists a long felt need in the art for an improved vehicle alert system. There is also a long felt need in the art for a safety device for children and pets that are left in locked vehicles. Additionally, there is a long felt need in the art for a novel safety system that can alert drivers and vehicle owners about children and pets left inside a vehicle. Moreover, there is a long felt need in the art for a novel safety system that alerts individuals near the vehicle about locked life form and a hazardous situation inside the vehicle. Furthermore, there is a long felt need in the art for a safety device that can be installed inside a vehicle and includes multiples sensors for detecting life form and hazardous situation inside the vehicle. Also, there is a long felt need in the art for a vehicle alarm system that enables emergency services to be contacted with a location for helping the locked child and pet inside a vehicle. Finally, there is a long felt need in the art for a safety device and system that monitors interior of a vehicle for hazardous situation and presence of a life form to alert driver, vehicle owner, nearby individuals, and emergency services.

The subject matter disclosed and claimed herein, in one embodiment thereof, comprises a safety system for identifying a life form inside a vehicle and for generating an alert when the situation is hazardous inside the vehicle. The system includes a device installed inside the vehicle. The device includes a 360-degree infra-red camera within a transparent dome. The device further includes a plurality of sensors including at least a motion sensor for detecting motion inside the vehicle, a CO2 sensor for detecting carbon dioxide inside the vehicle, a CO sensor for detecting carbon monoxide inside the vehicle, and a temperature sensor for monitoring temperature inside the vehicle, a processor for processing signals from the sensors and linking to vehicle's onboard GPS, weight sensors, alarm system and On-Star or similar system where available; and a wireless chip for establishing communication with a handheld electronic device, wherein the system is configured to generate alerts based on one or more sensor readings exceeding or subceeding a corresponding predetermined threshold. The system can alert one or more emergency services with GPS coordinates when the alerts are generated for more than a predetermined duration and is able to trigger the vehicle's onboard alarm system to attract the attention of passersby if there is not response within a safe response period. The alerts are generated on a smartphone application and as holographic images on windows of the vehicle.

In this manner, the locked life form safety and vehicle alarm system of the present invention accomplishes all of the forgoing objectives and provides users a safety sensor system that utilizes motion sensor, carbon dioxide sensor, a carbon monoxide sensor, an infrared camera, and other sensors for identifying a life form and hazardous conditions inside the vehicle. The system includes a smartphone application that can receive an alert from the sensor system when life form and hazardous conditions are detected. The system displays holographic images on windows and windshield of the vehicle, triggers the vehicle's onboard alarm system to generate the attention of those nearby, and enables emergency services to be contacted with a location of the vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a safety system for identifying a life form inside a vehicle and for generating an alert when the life form is inside the vehicle when the vehicle is locked. The system includes a safety device adapted to be installed inside the vehicle, the device includes a 360-degree infra-red camera within a transparent dome, the dome extends from the housing for capturing interior images of the vehicle. The device further includes a plurality of sensors including at least a motion sensor, a CO2 sensor, a CO sensor, and a temperature sensor, a processor for processing signals from the sensors and linking to vehicle's onboard GPS, weight sensors, alarm system, and On-Star or similar system; and a wireless chip for establishing communication with a handheld electronic device, wherein the system is configured to generate alerts based on one or more sensor readings exceeding or subceeding a corresponding predetermined threshold and is able to trigger the vehicle's onboard alarm system to attract the attention of passersby if there is no response within a safe response period.

In another aspect, a vehicle alarm system for detecting unsafe interior conditions of the vehicle is disclosed. The system includes a weatherproof housing attachable to a ceiling of the vehicle, a motion sensor for movement detection inside the vehicle, a CO2 sensor for detecting CO2 level inside the vehicle, a CO sensor for detecting CO levels inside the vehicle, and a temperature sensor for monitoring internal temperature of the vehicle, an infrared camera for thermal imaging of life forms in the vehicle, and a GPS sensor for vehicle location tracking; wherein the system is configured to automatically activate when the ignition of the vehicle is off and doors are locked, and the system alerts through a connected handheld electronic device when one or more sensors detect elevated or unsafe measurements. An alert is generated when the CO2 sensor detects an elevated CO2 level, or the temperature sensor detects a temperature exceeding or subceeding thresholds inside the vehicle, or the CO sensor detects elevated CO levels inside the vehicle, in response to detection of movement by motion sensor or life form by infrared camera.

In yet another embodiment, a vehicle alarm system is disclosed. The vehicle alarm system includes a safety device adapted to be installed inside a vehicle. The safety device works in conjunction with a smartphone application installed in a handheld electronic device. The system comprises a motion sensor, a CO2 sensor, a CO sensor, a temperature sensor, and an infrared camera for detecting life forms and unsafe interior cabin conditions, the handheld electronic device is coupled with the safety device using a wireless communication channel, the smartphone application is configured to receive notifications from the device when one or more sensor measurements exceed or subceed (i.e., outside) preset threshold ranges. When an alert is generated, a laser of the safety device projects holographic alerts on the windows and windshield of the vehicle.

In yet another embodiment, a method for monitoring the interior of a vehicle for notifying parents, guardians, and others when a vehicle interior becomes unsafe, and a life form is detected inside the vehicle. The method comprising the steps of attaching a sensor-equipped housing to ceiling of the vehicle, capturing images of the interior with a 360-degree camera, detecting motion inside the vehicle by a motion sensor, detecting CO2 levels inside the vehicle by a CO2 sensor, detecting CO levels inside the vehicle by a CO sensor, and detecting temperature inside the vehicle using a temperature sensor, detecting a life form image by an infrared sensor, comparing each sensor data with a corresponding threshold, generating alerts when measurements of one or more sensors exceed or subceed (i.e., outside) the corresponding pre-set threshold ranges, and wirelessly transmitting an alert to a smartphone application installed in a wirelessly connected handheld electronic device. A holographic display is also displayed on the windows and windshield of the vehicle for generating alerts for nearby users.

In a further embodiment, a method for generating emergency alerts in a vehicle is described. The method comprising the steps of detecting the presence of a life form inside a vehicle using one, or a combination, of a motion sensor, and an infrared sensor, detecting motion inside the vehicle using a motion sensor, detecting CO2 level inside the vehicle using a CO2 sensor, detecting CO levels inside the vehicle by a CO sensor, and detecting temperature inside the vehicle using a temperature sensor, processing sensor data with an onboard processor, generating and displaying holographic alerts on the windows and windshield of the vehicle when one or more sensor readings exceed or subceed (i.e., outside) predetermined threshold ranges, transmitting alert notifications to a connected smart device, triggering the vehicle's onboard alarm system to attract the attention of passersby if there is no response within a safe response period, and providing the location of the vehicle to an emergency service when the alerts are generated for at least a predetermined duration, wherein either the doors or windows of the vehicle are not opened during the predetermined duration.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the wide spectrum safety sensor of the present invention in accordance with the disclosed structure;

FIG. 2 illustrates a functional block diagram depicting internal sensors included in the wide spectrum safety sensor system of the present invention in accordance with the disclosed structure;

FIG. 3 illustrates a schematic view of connection of the wide spectrum safety sensor system with an electronic device in accordance with the disclosed architecture;

FIG. 4 illustrates a perspective view of the holographic display on the windows and windshield of the vehicle by the wide spectrum safety sensor system of the present invention;

FIG. 5 illustrates a flow chart depicting a process of generating alert by the wide spectrum safety sensor system in accordance with the disclosed structure;

FIG. 6 illustrates another flow chart depicting a process of alerting emergency services by the wide spectrum safety sensor system in accordance with the disclosed architecture; and

FIG. 7 illustrates a perspective view of a user receiving an alert notification from the wide spectrum safety sensor system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved vehicle alert system. There is also a long felt need in the art for a safety device for children and pets that are left in locked vehicles. Additionally, there is a long felt need in the art for a novel safety system that can alert drivers and vehicle owners about children and pets left inside a vehicle. Moreover, there is a long felt need in the art for a novel safety system that alerts individuals near the vehicle about locked life form and a hazardous situation inside the vehicle. Furthermore, there is a long felt need in the art for a safety device that can be installed inside a vehicle and includes multiples sensors for detecting life form and hazardous situation inside the vehicle. Also, there is a long felt need in the art for a vehicle alarm system that enables emergency services to be contacted with a location for helping the locked child and pet inside a vehicle. Finally, there is a long felt need in the art for a safety device and system that monitors interior of a vehicle for hazardous situation and presence of a life form to alert driver, vehicle owner, nearby individuals, and emergency services.

The present invention, in one exemplary embodiment, is a method for monitoring the interior of a vehicle for notifying parents, guardians, and others when a vehicle interior becomes unsafe, and a life form is detected inside the vehicle. The method comprising the steps of attaching a sensor-equipped housing to ceiling of the vehicle, capturing images of the interior with a 360-degree infra-red camera, detecting motion inside the vehicle by a motion sensor, detecting CO2 levels inside the vehicle by a CO2 sensor, detecting CO levels inside the vehicle by a CO sensor, and detecting temperature inside the vehicle using a temperature sensor, comparing each sensor data with a corresponding threshold, generating alerts when measurements of one or more sensors exceed or subceed (i.e., outside) the corresponding pre-set threshold ranges, and wirelessly transmitting an alert to a smartphone application installed in a wirelessly connected handheld electronic device. A holographic display is also displayed on the windows and windshield of the vehicle for generating alerts for nearby users.

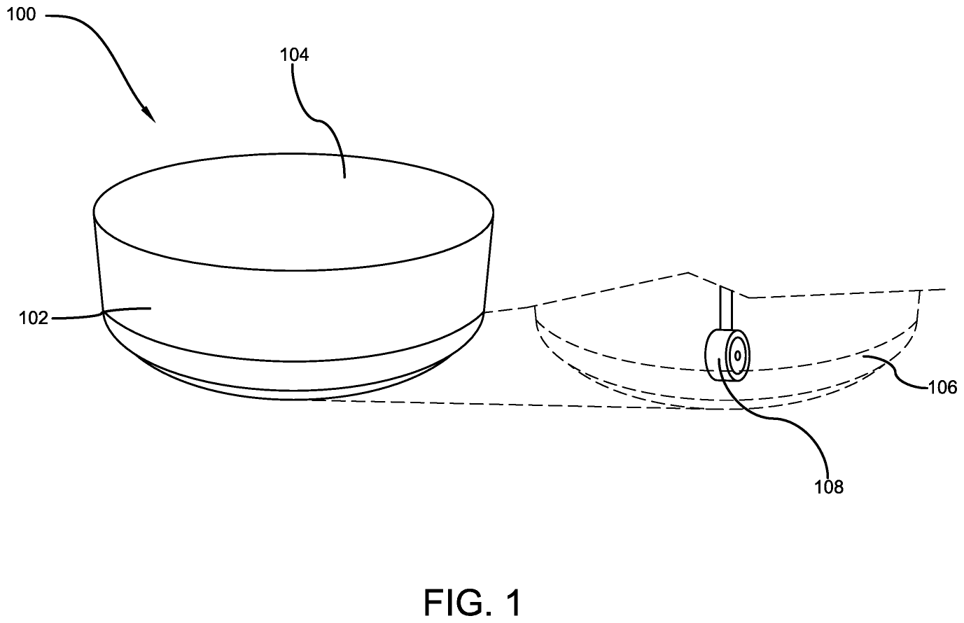

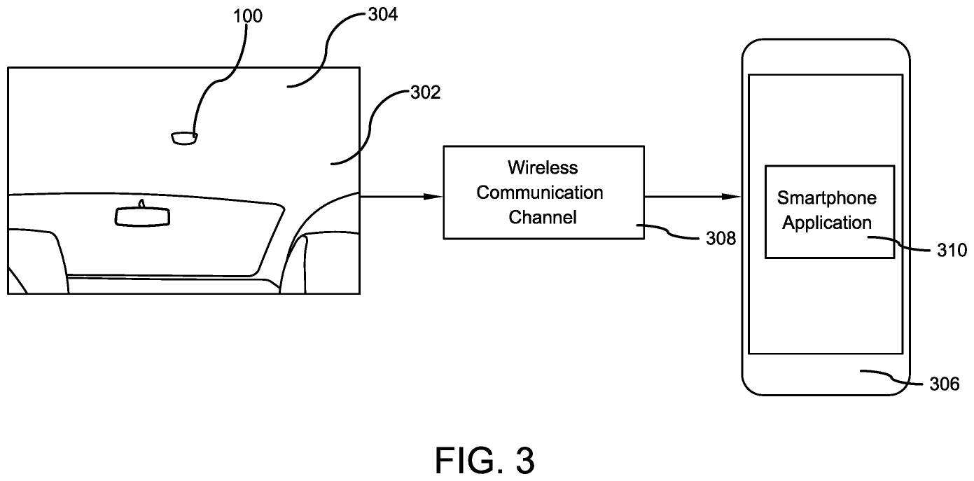

Referring initially to the drawings, FIG. 1 illustrates a perspective view of the wide spectrum safety sensor system of the present invention in accordance with the disclosed structure. The wide spectrum safety sensor 100 of the present invention is an advanced vehicle alarm system designed to prevent the dangers associated with leaving children, the elderly, disabled individuals, or pets in vehicles where the interior temperature of the vehicle reach unsafe levels. The wide spectrum safety sensor 100 can be integrated into a vehicle during manufacturing of the vehicle or can also be installed as an aftermarket product inside a vehicle. The sensor system 100 includes a housing 102 adapted to securely store different sensors included in the sensor system 100. The housing 102 is sealed, weatherproof and top surface 104 of the housing 102 and can be removably or permanently attached to ceiling or roof of a vehicle as illustrated in FIG. 3.

A transparent dome 106 extends down from the housing 102 and houses a 360-degrees camera 108. The camera 108 is adapted to capture and record the interior of the vehicle in which the safety sensor system 100 is installed. The sensor system 100 preferably functions using the integrated battery which can be replaced. Further, the battery of the sensor system 100 can be recharged using the electrical power of the vehicle when ignition of the vehicle is turned on.

The safety sensor system 100 can come in different shapes and sizes and has a compact size. In some embodiments, the vehicle alarm system 100 can be connected to the infotainment system or internal electrical circuit of the vehicle and is wirelessly connected to a handheld smart device such as a smartphone of owner of the vehicle for providing real time information of the interior of the vehicle.

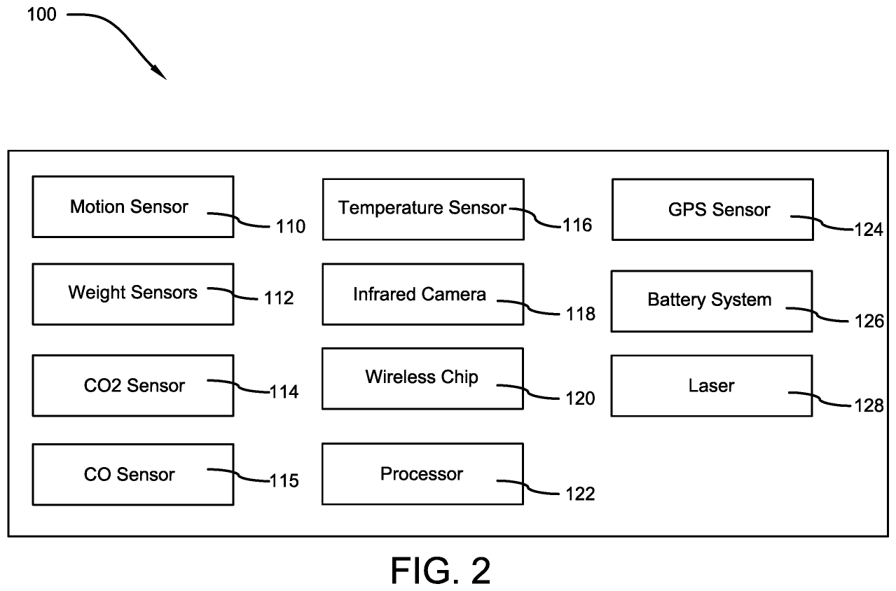

FIG. 2 illustrates a functional block diagram depicting internal sensors included in the wide spectrum safety sensor system of the present invention in accordance with the disclosed structure. The sensor system 100 includes a motion sensor 110 for detecting any movement inside the vehicle to detect movements from a child, pet, or any other life form. In some embodiments, the motion sensor 110 detects movement when doors of the vehicle are locked and ignition is turned off to save battery power of the sensor system 100.

A plurality of weight sensors 112 are included in the seats of the vehicle for measuring weight on the seats to detect an occupant based on the weight. The weight sensors 112 can be a part of the sensor system 100 and are wirelessly connected to the wide spectrum safety sensor 100. A carbon dioxide (CO2) sensor 114 is adapted to detect elevated CO2 levels inside the vehicle indicating respiration from humans or animals inside the vehicle. When the CO2 levels exceed a predetermined threshold, an alert can be generated by the sensor system 100. A carbon monoxide (CO) sensor 115 is adapted to detect elevated CO levels inside the vehicle indicating exhaust fumes are entering inside the vehicle. When the CO levels exceed a predetermined threshold, an alert can be generated by the sensor system 100.

A temperature sensor 116 configured for detecting internal temperature of the vehicle is included in the wide spectrum safety sensor 100. The temperature sensor 116 is preconfigured with a threshold temperature which is the maximum safe temperature (i.e., predetermined threshold safe temperature) for infants and animals. An infrared camera 118 is also included in the wide spectrum safety sensor 100 for detecting thermal energy of life forms inside the vehicle and for processing to form an image which can be displayed on the coupled handheld electronic device.

A wireless chip 120 of the wide spectrum safety sensor 100 establishes a wireless connection with at least one handheld electronic device as illustrated in FIG. 3 The wireless chip 120 can establish a long range or short-range wireless channel with the electronic devices enabling remote monitoring of the interior of the vehicle. Further, the wide spectrum safety sensor 100 is adapted to send notifications to the coupled electronic device when at least one sensor detects elevated or unsafe measurements (exceeding or subceeding the corresponding thresholds).

A processor 122 of the wide spectrum safety sensor 100 is configured to receive electric signals from the sensors of the wide spectrum safety sensor 100 and generate an alert and/or notification for alerting about a life form present inside the vehicle. The processor 122 can be Application-Specific Integrated Circuit (ASIC) processor, SoC processor, single core, or multicore processor.

For providing an exact location of the vehicle to emergency services when the alerts are generated for a long period of time (i.e., a predetermined period of time), a GPS sensor 124 is included in the wide spectrum safety sensor 100. The GPS sensor 124 is adapted to provide location of the vehicle to the processor 122 for contacting and alerting the emergency services for a quick rescue of life form present inside the vehicle.

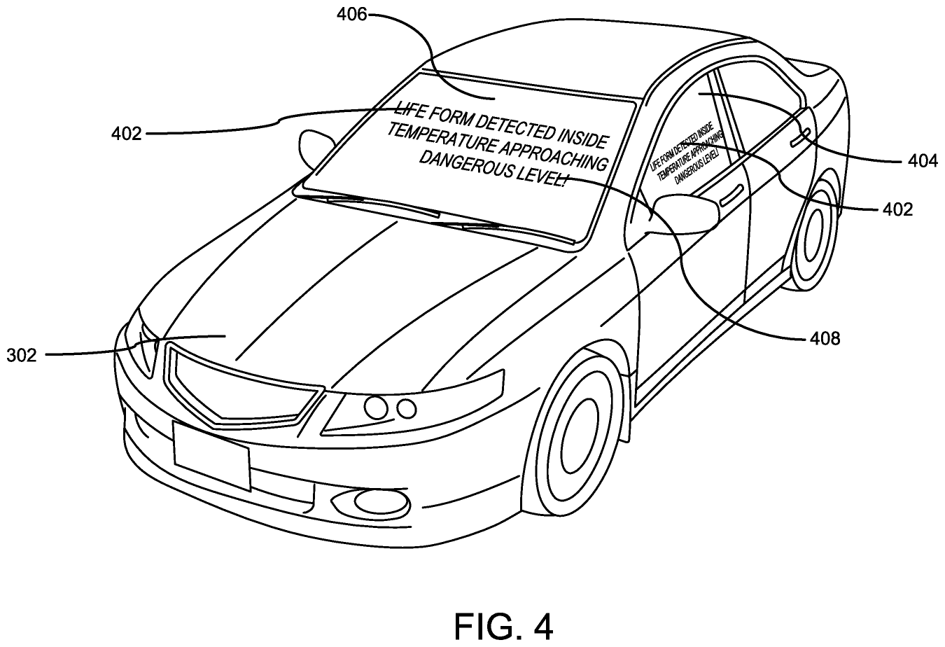

A battery system 126 provides electric power for functioning of the wide spectrum safety sensor 100. The battery system 126 can be rechargeable and can be recharged using the electric power of the vehicle in which the wide spectrum safety sensor 100 is installed. A laser 128 is used for projecting lights on the windows and windshield of the vehicle for generating a holographic alert display as illustrated in FIG. 4.

FIG. 3 illustrates a schematic view of connection of the wide spectrum safety sensor system with an electronic device in accordance with the disclosed architecture. The wide spectrum safety sensor 100 is preferably installed inside the vehicle 302 and on the roof 304 of the vehicle 302. At least one electronic device 306 is wirelessly coupled to the wide spectrum safety sensor 100 using a wireless communication channel 308. The wireless communication channel 308 can be Wi-Fi, Bluetooth, cellular, or any other wireless communication channel.

A smartphone application 310 is installed in the electronic device 306 and is used for receiving notifications or alerts from the wide spectrum safety sensor 100 when one or more thresholds of the sensors included in the sensor system 100 are exceeded or subceeded. Further, the smartphone application 310 can enable a user to activate/deactivate the safety sensor system 100 for power saving.

FIG. 4 illustrates a perspective view of the holographic display on the windows and windshield of the vehicle by the wide spectrum safety sensor system 100 of the present invention. The wide spectrum safety sensor system 100 of the present invention is designed to display a holographic 402 on each window 404 and windshield 406 of the vehicle 302. The holographic 402 is displayed when one or more sensors detect a measurement exceeding or subceeding the corresponding threshold. The holographic 402 is configured to display a message 408 indicating presence of a life form inside the vehicle 302 with temperature or CO2 level inside the vehicle reaching dangerous level.

The holographic 402 functions as an alert to users nearby the vehicle 302 and can help in opening the vehicle 302 and taking out the life form from inside the vehicle 302. The laser 128 is activated automatically for projecting light on the windows and windshield for creating a holographic. In some embodiments, the holographic 402 can be customized based on the sensor which detects the elevated or unsafe measurements. For example, the holographic 402 may indicate temperature when the temperature sensor 116 detects exceeded or subceeded temperature thresholds and may indicate CO2 when the CO2 sensor 114 detects elevated CO2 level inside the vehicle.

The holographic 402 can be customized using the smartphone application 310 including the color, text, font and more. Further, the laser 128 can also be selectively deactivated using the smartphone application 310.

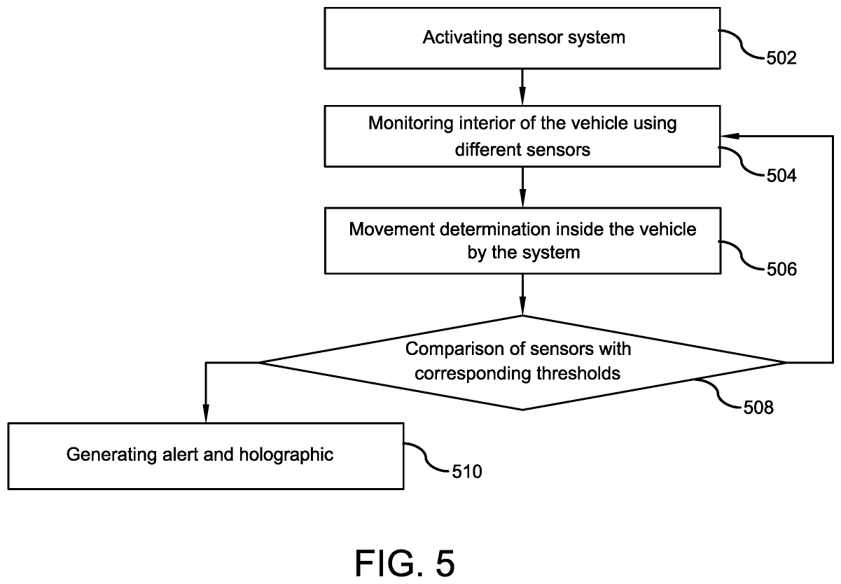

FIG. 5 illustrates a flow chart depicting a process of generating alert by the wide spectrum safety sensor system in accordance with the disclosed structure. Initially, the system 100 is activated (Step 502). The system 100 can be manually activated by a user or can also be automatically activated when the doors are locked or the ignition of the vehicle is turned off.

Then, the different sensors of the wide spectrum safety sensor system 100 monitor the interior of the vehicle (Step 504). All the sensors are automatically activated and measure the corresponding parameters for the safety of any life form inside the vehicle. Thereafter, the information from one or more of the motion sensors, CO sensor, and the infrared camera is used by the sensor system 100 to determine the movement and presence of any life form inside the vehicle (Step 506). A comparison of the measurements by each sensor is performed with the corresponding preconfigured threshold for detecting an alert condition for generating an alert and/or holographic (Step 508). In case one of the sensors detects a life form, combined with one or more sensor detecting unsafe vehicle cabin conditions (elevated or unsafe measurements), then, an alert is generated by transmitting a notification to the smartphone application 310 and generating a holographic 402 (Step 510). Simultaneously, holographic 402 is also displayed on each window and windshield for alerting nearby passersby.

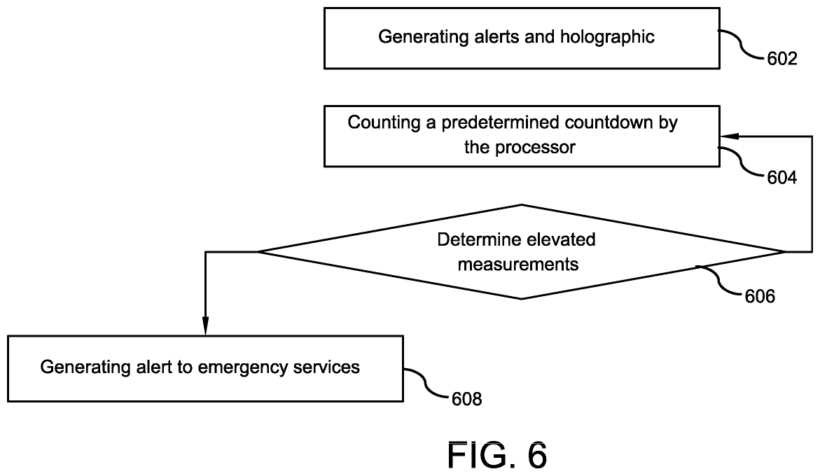

FIG. 6 illustrates another flow chart depicting a process of alerting emergency services by the wide spectrum safety sensor system in accordance with the disclosed architecture. Initially, the alerts and holographic are generated by the system 100 when a life form is detected inside the vehicle and one of the sensors detects an elevated or unsafe measurement (Step 602). Then, the processor 122 of the system 100 counts a countdown for a predetermined duration (Step 604) and in case the doors or windows of the vehicle are not opened or one or more sensors continue to detect elevated or unsafe measurement (Step 606), then a notification is sent to the emergency services (Step 608) wherein the notification can include location of the vehicle along with an identification of the paired smart device.

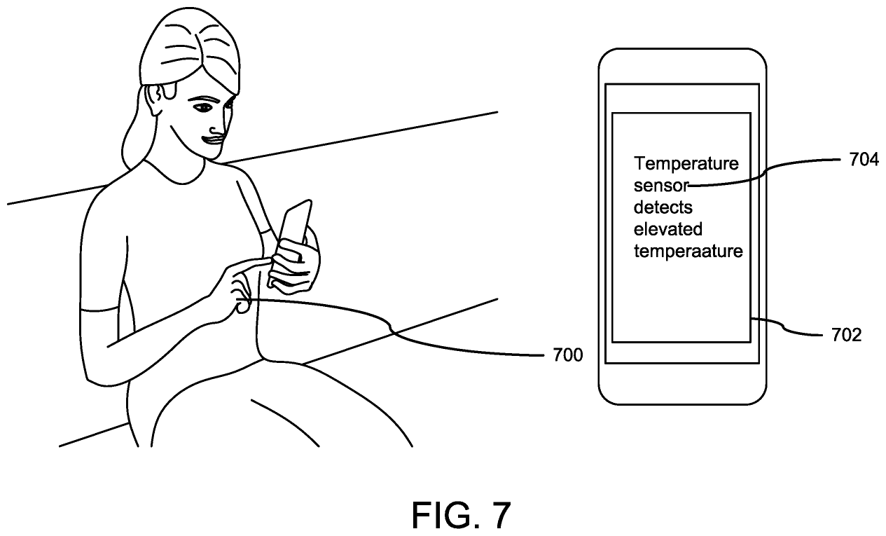

FIG. 7 illustrates a perspective view of a user receiving an alert notification from the wide spectrum safety sensor system 100 in accordance with the disclosed architecture. The user 700 such as vehicle owner can receive notification 702 from the system 100 when an emergency situation is detected based on the elevated or unsafe measurements. The notification 702 can include sensor information 704 which detects the elevated or unsafe measurements. In some embodiments, location of the vehicle can also be included in the notification.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “electronic device” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle alarm system”, “safety sensor system”, “wide spectrum safety sensor”, “safety system”, “safety device”, and “system” are interchangeable and refer to the wide spectrum safety sensor and vehicle alarm system 100 of the present invention.

Notwithstanding the forgoing, the wide spectrum safety sensor and vehicle alarm system 100 of the present invention can be of any suitable configuration as is known in the art without affecting the overall concept of the invention, provided that it accomplishes the above-stated objectives. One of ordinary skill in the art will appreciate that the configuration and specification of the components of the wide spectrum safety sensor and vehicle alarm system 100 as shown in FIGS. is for illustrative purposes only, and that many other configurations of the wide spectrum safety sensor and vehicle alarm system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A safety sensor for a vehicle alarm system comprising:
a housing having a plurality of sensors; and
wherein said plurality of sensors selected from the group consisting of a camera sensor, a motion sensor, and a temperature sensor;
wherein said motion sensor detects movement inside a vehicle for detecting movements from a life form; and
further wherein said motion sensor actuates when doors of the vehicle are locked and an ignition of the vehicle is off.

2. The safety sensor for a vehicle alarm system of claim 1 further comprising a carbon dioxide (CO2) sensor to detect a CO2 level inside the vehicle, wherein when said CO2 level exceeds a predetermined threshold CO2 level an alert is generated by said plurality of sensors.

3. The safety sensor for a vehicle system of claim 2, wherein said temperature sensor detects a temperature inside the vehicle; and further wherein when said temperature is outside a predetermined threshold temperature range an alert is generated by said plurality of sensors.

4. The safety sensor for a vehicle system of claim 3, wherein said camera sensor is an infrared camera for detecting thermal energy of life forms inside the vehicle.

5. The safety sensor for a vehicle system of claim 4, further comprising a carbon monoxide (CO) sensor to detect a CO level inside the vehicle, wherein when said CO level exceeds a predetermined threshold CO level an alert is generated by said plurality of sensors.

6. The safety sensor for a vehicle system of claim 5, wherein said life form is selected from the group consisting of a child and a pet.

7. The safety sensor for a vehicle system of claim 6, wherein said housing having a transparent dome bottom surface extending downward for housing said camera.

8. The safety sensor for a vehicle system of claim 7, wherein said camera is a 360-degree camera for capturing and recording an interior of the vehicle.

9. The safety sensor for a vehicle system of claim 8, wherein said plurality of sensors powered by an integrated replaceable battery.

10. The safety sensor for a vehicle system of claim 9, wherein said plurality of sensors powered by a rechargeable battery and further wherein said rechargeable battery recharged with electrical power of the vehicle when ignition of the vehicle is turned on.

11. The safety sensor for a vehicle system of claim 10, wherein said plurality of sensors is wirelessly connected to a handheld smart device for providing real time information from said plurality of sensors to an owner of the vehicle.

12. A safety sensor for a vehicle alarm system comprising:
a housing having a plurality of sensors; and
wherein said plurality of sensors selected from the group consisting of a camera sensor, a motion sensor, a GPS sensor, and a temperature sensor;
wherein said motion sensor detects movement inside a vehicle for detecting movements from a life form;
wherein said motion sensor actuates when doors of the vehicle are locked and an ignition of the vehicle is off; and
further wherein said GPS sensor provides a location of the vehicle to emergency services when an alert is generated for a predetermined period of time.

13. The safety sensor for a vehicle alarm system of claim 12 further comprising a carbon dioxide (CO2) sensor to detect a CO2 level inside the vehicle and a carbon monoxide (CO) sensor to detect CO level inside the vehicle, wherein when said CO2 level exceeds a predetermined threshold CO2 level, or when said CO level exceeds a predetermined threshold CO level, an alert is generated by said plurality of sensors.

14. The safety sensor for a vehicle system of claim 12, wherein said temperature sensor detects a temperature inside the vehicle; and further wherein when said temperature is outside a predetermined threshold temperature range an alert is generated by said plurality of sensors.

15. The safety sensor for a vehicle system of claim 12, wherein said camera sensor is an infrared camera for detecting thermal energy of life forms inside the vehicle.

16. The safety sensor for a vehicle system of claim 12, wherein said plurality of sensors powered by a rechargeable battery, and further wherein said rechargeable battery recharged with electrical power of the vehicle when ignition of the vehicle is turned on.

17. The safety sensor for a vehicle system of claim 12, wherein said plurality of sensors are wirelessly connected to a handheld smart device for providing real time information from said plurality of sensors to an owner of the vehicle.

18. A method for detecting presence of life form inside a vehicle, the method comprising the steps of:
providing a housing including a plurality of sensors, wherein said plurality of sensors selected from the group consisting of a camera sensor, a motion sensor, a GPS sensor, a CO2 sensor, a CO sensor, a temperature sensor, and further wherein said motion sensor detects movement inside a vehicle for detecting movements from a life form;
actuating said plurality of sensors when doors of the vehicle are locked and an ignition of the vehicle is off;
detecting movements inside a vehicle;
providing a location of the vehicle to emergency services with said GPS sensor when an alert is generated for a predetermined period of time; and
wirelessly connecting said plurality of sensors to a handheld smart device for providing real time information from said plurality of sensors to an owner of the vehicle.

19. The method for detecting presence of life form inside a vehicle of claim 18 further comprising said CO2 sensor detecting a CO2 level inside the vehicle and said CO sensor detecting a CO level inside the vehicle, wherein when said CO2 level exceeds a predetermined threshold CO2 level, or when said CO level exceeds a predetermined threshold CO level, an alert is generated by said plurality of sensors.

20. The method for detecting presence of life form inside a vehicle of claim 18 further comprising a step of displaying a holographic on at least one window of the vehicle as a message when one or more of said plurality of sensors exceed or subceed a corresponding predetermined threshold range.
